(19) United States
(12) Patent Application Publication
(10) Pub. No.: US 2009/0300126 A1
(43) Pub. Date: Dec. 3, 2009

(54) Message Handling

(75) Inventor: Andrew J. Menadue, Hampshire (GB)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/431,159

(22) Filed: Apr. 28, 2009

(30) Foreign Application Priority Data
May 30, 2008 (EP) 08157337.0

(51) Int. Cl. G06F 15/16

(52) U.S. Cl. 709/206

(57) ABSTRACT

A mechanism is provided for handling a message being transmitted from a sender to a recipient. A processing component receives a message from the sender and information identifying the recipient. The processing component access a first predefined ruleset for the identified recipient and applies the first predefined ruleset to the message. The processing component identifies infringements of the first predefined ruleset within the message. Based on identifying a set of identified infringements of the first predefined ruleset within the message, the processing component either corrects the identified infringements of the first predefined ruleset within the message or presents the identified infringements of the first predefined ruleset within the message to the sender. The processing component transmits a corrected message to the recipient.

### BACKGROUND

This invention relates to a provided a method of, and a system for, handling a message.

The widespread use of computers in the business and personal environment that are connected via networks such as the Internet has lead to the common use of electronic communication via exchanging messages. Two such messaging technologies are email and instant messaging. Email (electronic mail) is a store and forward method of composing, sending, receiving and storing messages using electronic communication systems of client devices and servers. Instant messaging is a technology that allows text based communication between two or more participants over a network. Instant messaging allows communication between a number of parties simultaneously, by transmitting information quickly. Instant messaging allows effective and efficient communication, featuring immediate receipt of acknowledgment or reply. The nature of such systems, which are able to place people around the World in communication with each other in an informal manner, has lead to a number of difficulties.

Improvements in such systems are known. For example United States of America Patent Application Publication US 2007/0208813 discloses a machine translation instant messaging application. This publication discloses an instant messaging translation plug-in, which interacts with an instant messaging program, to intercept incoming messages and forward these messages to a language translation service. The plug-in then displays a translation received from the service along with the original message. This provides translation which can be used by instant messaging users to communicate across language barriers, and without local translation or knowledge of the internal workings of the translation services used. Additionally, the translation plug-in also provides for manual translation of messages, which allows communication with users who use a different language but do not use the translation plug-in. Messages are modified before translation in order to correct spelling, to prevent particular words or phrases from being translated, and to change instant messaging language into standard language form. The techniques can be performed on various messaging services, including instant messaging on computers or mobile devices, as well as SMS.

There are no known messaging systems that are able to compensate for cultural differences in communicating parties. Messaging systems such as instant messaging provide a method of communication that is being used more frequently, and very often is used between people in different countries, and, more importantly in different cultures. This can lead to problems in communication, due to the effect known as cyberdisinhibition, or the tendency to ignore protocols when using digital communication methods. There do not exist any tools that are designed to address this problem directly.

### SUMMARY

In one illustrative embodiment, a mechanism is provided for handling a message being transmitted from a sender to a recipient. The illustrative embodiment receives a message from the sender. The illustrative embodiment receives information identifying the recipient. The illustrative embodiment accesses a first predefined ruleset for the identified recipient. The illustrative embodiment applies the first predefined ruleset to the message. The illustrative embodiment identifies infringements of the first predefined ruleset within the message. Based on identifying a set of identified infringements of the first predefined ruleset within the message, the illustrative embodiment either corrects the identified infringements of the first predefined ruleset within the message or presents the identified infringements of the first predefined ruleset within the message to the sender. The illustrative embodiment transmits a corrected message to the recipient.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

Embodiments of the present invention will now be described, by way of example only, with reference to the accompanying drawings, in which:

FIG. 1 is a schematic diagram of a system for handling a message,

FIG. 2 is a schematic diagram of a client device of the system of FIG. 1,

FIG. 3 is a schematic diagram of a server of the system of FIG. 1,

FIG. 4 is a schematic diagram of a display device of the client device of FIG. 2, showing a graphical user interface, and

FIG. 5 is a flowchart of a method of handling the message.

### DETAILED DESCRIPTION

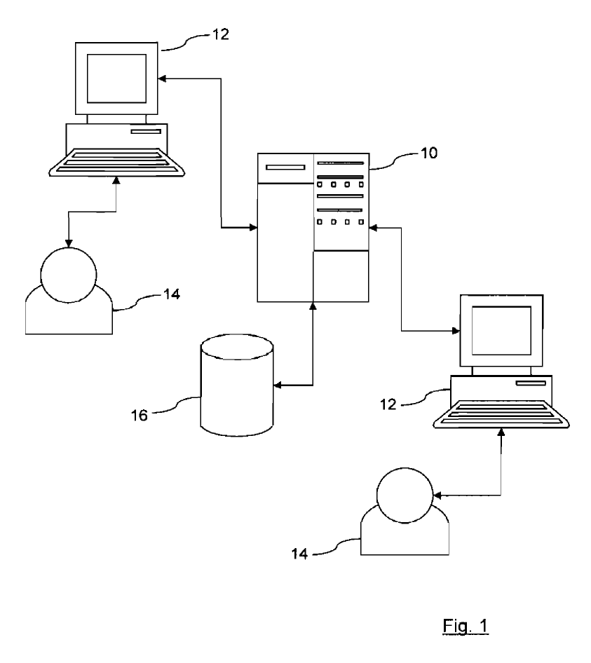

An example of a messaging system is shown in FIG. 1. The embodiment that is described with reference to this Figure is an instant messaging system. The system comprises a server 10 and two client devices 12. The server 10 is running an instant messaging application, and each of the client devices 12 is running a client program that communicates with the instant messaging application that is being maintained by the server 10. In this example, only two client devices 12 are shown for clarity purposes. However, multiple client devices 12 can be connected to the server 10, and indeed multiple servers 10 can be used, with the function of the instant messaging application being distributed across the multiple servers 10.

Each client device 12 is associated with a user 14, who accesses the client program that is being run by their respective client device 12. The user 14 will log into the client program using a username and password, and the client program will notify the application that is being run by the server 10, that the specific user 14 is now available for instant messaging. When two users 14 wish to communicate via instant messaging, then one of the users 14 must initiate a session with the other user 14, normally in a well defined manner.

The server 10 maintains the session that is taking place between the two users 14. Whenever a user 14 types a message at their respective client device 12, then that message is sent from their client program to the instant messaging application at the server 10. The server 10 then transmits this message to the other client device 12 participating in the session. If there are multiple users 14 in the session then the server 10 will transmit that message to the multiple client devices 12 associated with those users 14.

The server 10 is also connected to a database 16, which is a cultural rules database 16. The instant messaging application, run by the server 10, has access to the content of this cultural rules database 16. The database 16 stores multiple rulesets which each are associated with a specific cultural identity, which can be based on geography, language or nationality or any other suitable characterising type. The function of the database 16 and the rulesets that are stored therein is discussed in more detail below, with reference to FIG. 3.

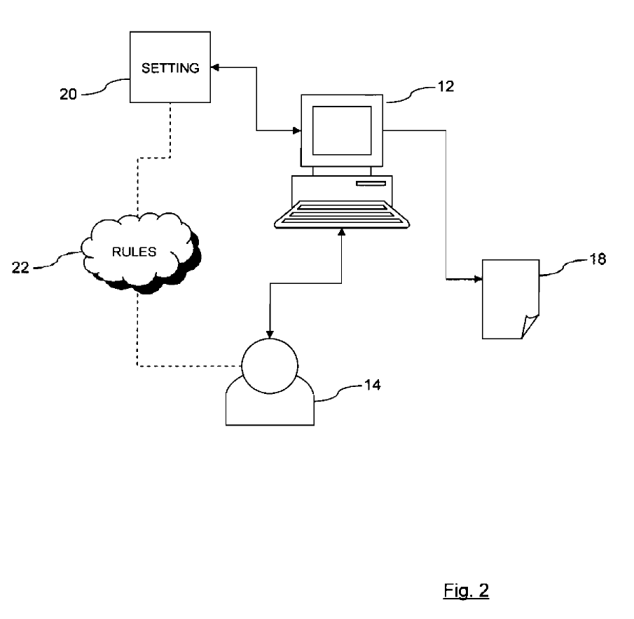

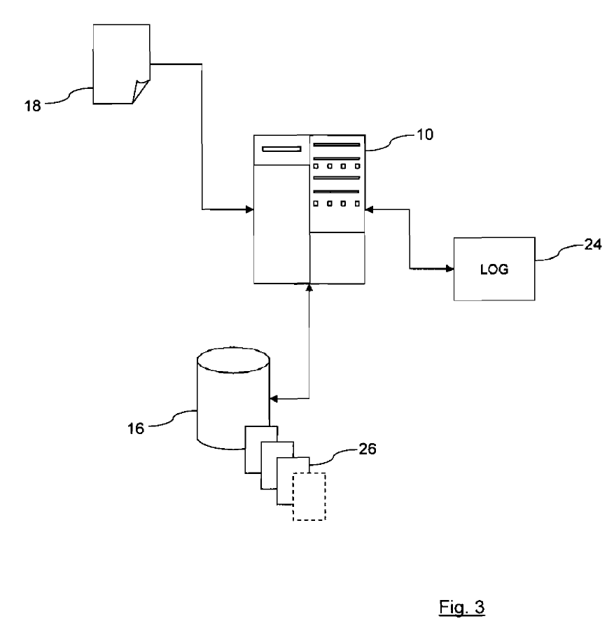

FIG. 2 shows more detail of the system at the client end of the messaging process. The client device 12 is operated by the user 14, who has logged into their local messaging client program, and is participating in an instant messaging session with another user 14, who is remote from the user 14 shown in the Figure. When the user 14 wishes to send a message 18 to the participating user 14, then they will type in the message at the graphical user interface of their local client application and press send. The client device 12 is then operated to transmit the message 18 to the appropriate server 10 that is maintaining the current instant messaging session.

The nature of messaging applications such as instant messaging is that they encourage quick and informal responses to the messaging thread (or conversation) that is currently taking place. Since, by its character, such messaging does not include the normal human communication elements of tone and intonation of the user's voice, and body language and other non-verbal cues, it is easy to draft a message 18 that could be considered brusque or rude by the recipient. It is also the case that the globalisation of business and personal communication has lead to widespread contact between people who have very different cultural norms, even if they are working in the same organisation, in the same function, and at the same hierarchical level. This can lead to the unintentional use (or misuse) of language.

The invention of the present application is designed to address these issues. The user 14 has a cultural setting 20 associated with them. This setting is accessible by the client device 12. For example, when the user 14 logs into the local messaging client, then the acceptance of their login and communication with the server 10 includes the recalling of the user's specific setting 20. The user's cultural setting 20 is transmitted to the server 10, as a prerequisite to the user 14 participating in an instant messaging session. This can all be done as part of the registration with the server 10 that takes place when a client program connects to the application run by the server 10. The setting effectively determines rules 22 that apply to the user 14. These rules 22 are not necessarily explicitly stated at the local client device 14, effectively, the setting 20 is a pointer to the rules 22 that apply to the specific user 14.

The server 10 is shown in more detail in FIG. 3. The server 10 receives the message 18, which has been transmitted by the client device 12 for the user 14.

The server 10 has access to a log 24, which is maintaining details of the current session(s) being run by the instant messaging application. This log 24 includes details of the recipient of the message 18, defined by the other users who are participating in the specific instant messaging session. The server 10 is able to access the log 24 for any incoming message 18, to identify the intended recipient of the message 18.

The server 10 is also connected to the cultural database 16, which is storing a plurality of rulesets 26. These rulesets 26 define one or more rules that can be applied to the text within a message 18. The rulesets 26 can be stored by the database 16 as is, or can be generated dynamically in the sense that they can be assembled from smaller fragments depending upon one or more factors relating to the intended recipient. As discussed above, with reference to FIG. 2, each participant in the instant messaging session has communicated to the server 10 their respective cultural setting 20. This setting 20 is effectively a ruleset indicator for the sender. The setting 20 is used with respect to deciding which ruleset 26 is to be used for that recipient, regardless of whether the choice is a preexisting ruleset 26, or one that is dynamically created.

The server 10 is arranged to process the message 18 by accessing a predefined ruleset 26 for the identified recipient, applying the ruleset 26 to the message 18, and identifying infringements of the ruleset 26 within the message 18. A processing component (not shown) within the server 10 is arranged to carry out these steps, every time a message 18 is received by the server 10. Effectively, the server 10 churns through the rules in the selected ruleset 26 with respect to the received message 18, in order to detect any infringements of the rules in the ruleset 26. Once this has been done, the server 10 is arranged to either correct the identified infringements within the message 18, or to present the identified infringements within the message 18 to the client device 12, from which the original message 18 was received.

The preferred embodiment of the invention is for the identified infringements within the message 18 to be transmitted back to the client device 12, so that the user 14 has the option of reviewing those changes and deciding whether they wish to accept the changes or to ignore the changes. The server 10 is therefore configured to send back a query message to the client device 12 that originally sent the message 18. If no infringements of the chosen ruleset 26 are detected, then the server 10 does not reply to the client device 12, simply transmitting the message 18 on to the intended recipient, as defined by the current instant messaging session.

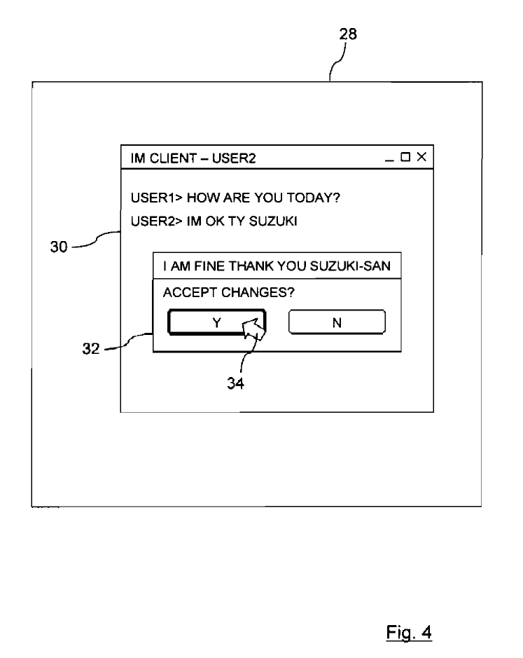

FIG. 4 shows an example of how the client device 12 could be configured to deal with the query message coming back to the local instant messaging client from the application run by the server 10. This Figure shows a display device 28 that forms part of the client device 12. The display device 28 shows a graphical user interface 30 to the local instant messaging client being run by the client device 12. The graphical user interface 30 is headed “IM CLIENT-USER2”. This refers to an instant messaging client session, with the user 14 being logged in as “USER2”. The current session is being shown in the part of the interface 30 below the header.

The message that the user2 has typed into the client interface 30 is the message “IM OK TY SUZUKI”. This message would be readily understood by a native English speaker who is sufficiently well versed in the vernacular use of language that pervades network messaging (such as used in email and instant messaging). The user2 has dropped grammatical conventions and used abbreviations and also used user1's name without the proper culturally correct suffix. This message, once the user2 has pressed send will have gone to the server 10, been checked, and then a corrected version will have been sent back by the server 10 to the client device 12. This results in the graphical user interface 30 generating a sub-window 32, which includes a component that presents the identified infringements of the ruleset 26 of the recipient in the form of a corrected version. This is “I AM FINE THANK YOU SUZUKI-SAN”. The user 14 now has the opportunity to accept or decline the changes made by the server 10, by using the cursor 34 to make the appropriate choice. If the user accepts the changes, the corrected version of the original message is sent to the intended recipient, and if the user declines the changes then the original message 18 is sent to the recipient.

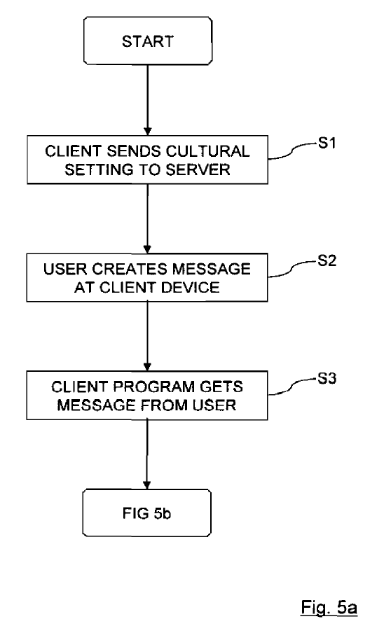

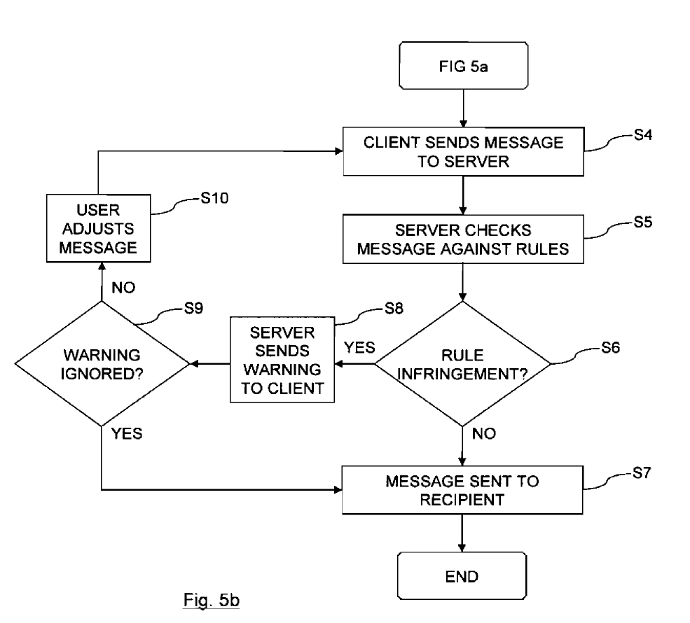

One embodiment of the methodology described above is illustrated in FIG. 5, which shows a flowchart of a method of handling the message 18. The first step, step S1, is the step of transmitting from the client device 12 to the server 10 the cultural setting 20 of the user 14 that is participating in the instant messaging session. The next step, S2, is the step of the user 14 entering a message 18, which they wish to send to a specific recipient, at the text editor of the client program. Once the user has completed the desired message 18, then the user will press send, and at step S3, the client instant messaging program receives the message 18 as one ready to be transmitted to the instant messaging application being run by the server 10.

The next step in the process is the step of sending the message 18 from the client device 10 to the server 12, as shown by step S4. Once the server 10 has received the message 18 from the client device 10, then at step S5, the server 10 is arranged to check the message 18 against the rules in the appropriate ruleset 26. This step is described in detail above with reference to FIG. 4. The server 10 recalls the correct ruleset 26 from the database 16 and, at step S6 identifies any rules infringements within the message 18. If no infringements are detected, then the message 18 is sent to the recipient, at step S7.

If rules infringements are detected, at step S6, then the method proceeds to step S8. At this step, the server 10 sends a warning back to the client device 12 that sent the message 18 originally, indicating that one or more rules infringements have been detected. The client device 12 handles the warning as appropriate, and gives the user 14 the option of accepting or declining the changes that have been made to the message 18. If the warning is ignored, then the process again moves to step S7, sending the unamended message 18 to the recipient and terminating.

If the user 14 decides not to ignore the warning and adjusts the message at step S10 (which may be achieved by accepting the proposed amendments made by the server 10), then a new amended message is sent by client device 12 to the server 10, and the process of checking the message 18 is repeated. Once a message 18 has no rules infringements, or the user 14 chooses to ignore the proposed changes to the message 18, then the process will move to the step S7 of sending the message (whether amended or not) to the intended recipient.

The fundamental part of the process is that the server checks the message 18 to see if there are any rules infringements within the message 18, before it is sent to the recipient. Virtually all of the other aspects of the process could be implemented in a different manner. For example, there is no need to have a feedback loop to the client device 12. The server 10 could be configured to make the changes directly on the message 18, without querying those changes with the original sender of the message 18.

The process described in FIG. 5 also works perfectly well if there are multiple intended recipients. For example, this might occur if the instant message session has three or more participants, or if the messaging is an email message that is to be sent to multiple individuals. In this case, the rule infringement steps S5 and S6 are repeated for each possible recipient, assuming that they have different profiles. The original sender of the message 18 can then be presented with different amended emails for different recipients.

All of the above embodiments are described in the context of the rule checking taking place at the instant messaging server 10. However, this handling of the message 18 by comparing the message 18 against a ruleset determined by the recipient could take place anywhere in the communication chain. There is no reason why the handling could not take place at the client device 12, before any message 18 is sent to the server 10. All of the steps that relate to the direct handling of the message 18 would then be carried out at the client device 12. Similarly, a separate server may be designated for the rules querying. This server would communicate with the instant messaging server 12, but would have all of the handling tasks delegated to this separate server.

1. A method, in a processing component of a server, for handling a message being transmitted from a sender to a recipient, the method comprising:
receiving, by the processing component, a message from the sender,
receiving, by the processing component, information identifying the recipient,
accessing, by the processing component, a first predefined ruleset for the identified recipient,
applying, by the processing component, the first predefined ruleset to the message,
identifying, by the processing component, infringements of the first predefined ruleset within the message and based on identifying a set of identified infringements of the first predefined ruleset within the message either correcting, by the processing component, the identified infringements of the first predefined ruleset within the message, or presenting, by the processing component, the identified infringements of the first predefined ruleset within the message to the sender, and
transmitting, by the processing component, a corrected message to the recipient.

2. The method according to claim 1, further comprising:
transmitting, from a client device, a ruleset indicator for the sender to the processing component.

3. The method according to claim 1, further comprising:
following presenting of the identified infringements of the first redefined ruleset within the message to the sender, receiving, by the processing component, an amended message from the sender,
applying, by the processing component, the first predefined ruleset to the amended message,
identifying, by the processing component, infringements of the first predefined ruleset within the amended message and based on identifying a set of identified infringements of the first predefined ruleset within the amended message either correcting the infringements of the first predefined ruleset within the amended message or presenting the infringements of the first predefined ruleset for the amended message to the sender.

4. The method according to claim 1, further comprising:
following presenting of the identified infringements of the first predefined ruleset within the message to the sender, receiving, by the processing component, an ignore command from the sender, and
transmitting, by the processing component, an uncorrected message to the recipient.

5. The method according to claim 1, further comprising:
receiving, by the processing component, information identifying a second recipient,
accessing, by the processing component, a second predefined ruleset for the identified second recipient, the second predefined ruleset being different from the first predefined ruleset,
applying, by the processing component, the second predefined ruleset to the message,
identifying, by the processing component, infringements of the second predefined ruleset and based on identifying a set of identified infringements of the ruleset within the message either correcting the identified infringements of the second redefined ruleset within the message or presenting the identified infringements of the second predefined ruleset within the message to the sender, and
transmitting, by the processing component, a corrected message to the second recipient.

6. A system for handling a message being transmitted from a sender to a recipient, the system comprising:
a server device arranged to receive a message and to receive information identifying the recipient from a client device, and
a processing component within the server arranged to:
access a first predefined ruleset for the identified recipient,
apply the first predefined ruleset to the message,
identify infringements of the first redefined ruleset within the message and based on identifying a set of identified infringements of the first predefined ruleset within the message either correct the identified infringements of the first predefined ruleset within the message, or present the identified infringements of the first predefined ruleset within the message to the client device, and
transmit a corrected message to the recipient.

7. The system according to claim 6, wherein the client device is further arranged to transmit a ruleset indicator to the processing component.

8. The system according to claim 6, wherein the processing component is further arranged to:
following presenting of the identified infringements of the first predefined ruleset within the message to the sender, receive an amended message from the sender,
apply the first predefined ruleset to the amended message,
identify infringements of the first redefined ruleset within the amended message and based on identifying a set of identified infringements of the first predefined ruleset within the amended message either correct the infringements of the first predefined ruleset within the amended message or present the infringements of the first redefined ruleset for the amended message to the sender.

9. The system according to claim 6, wherein the processing component is further arranged to:
following presenting of the identified infringements of the first predefined ruleset within the message to the sender, receive an ignore command from the sender, and
transmit an uncorrected message to the recipient.

10. The system according to claim 6, wherein the processing component is further arranged to:
receive information identifying a second recipient,
access a second predefined ruleset for the identified second recipient, the second predefined ruleset being different from the first predefined ruleset,
apply the second redefined ruleset to the message,
identify infringements of the second predefined ruleset and based on identifying a set of identified infringements of the second predefined ruleset within the message either correct the identified infringements or second redefined ruleset within the message or present the identified infringements of the second predefined ruleset within the message to the sender, and
transmit a corrected message to the second recipient.

11. A computer program product comprising a computer recordable medium having a computer readable program recorded thereon, wherein the computer readable program, when executed on a computing device, causes the computing device to:
receive a message for a recipient from a sender,
receive information identifying the recipient,
access a first predefined ruleset for the identified recipient,
applying the first predefined ruleset to the message,
identify infringements of the first predefined ruleset within the message and based on identifying a set of identified infringements of the first predefined ruleset within the message either correct the identified infringements of the first predefined ruleset within the message, or present the identified infringements of the first predefined ruleset within the message to the sender, and
transmit a corrected message to the recipient.

12. The computer program product according to claim 11, wherein the computer readable program further causes the computing device to:
receive a ruleset indicator for the sender.

13. The computer program product according to claim 11, wherein the computer readable program further causes the computing device to:
following presenting of the identified infringements of the first redefined ruleset within the message to the sender, receive an amended message from the sender,
apply the first predefined ruleset to the amended message,
identify infringements of the first redefined ruleset within the amended message and based on identifying a set of identified infringements of the first predefined ruleset within the amended message either correct the infringements of the first predefined ruleset within the amended message or present the infringements of the first predefined ruleset for the amended message to the sender.

14. The computer program product according to claim 11, wherein the computer readable program further causes the computing device to:
following presenting of the identified infringements of the first redefined ruleset within the message to the sender, receive an ignore command from the sender, and
transmit an uncorrected message to the recipient.

15. The computer program product of claim 11, wherein the computer readable program further causes the computing device to:
receive information identifying a second recipient,
access a second predefined ruleset for the identified second recipient, the second predefined ruleset being different from the first predefined ruleset,
apply the second predefined ruleset to the message,
identify infringements of the second predefined ruleset and based on identifying a set of identified infringements of the second predefined ruleset within the message either correct the identified infringements of the second predefined ruleset within the message or present the identified infringements of the second predefined ruleset within the message to the sender, and
transmit a corrected message to the second recipient.
